(19) United States
(12) Patent Application Publication
(10) Pub. No.: US 2026/0116173 A1
(43) Pub. Date: Apr. 30, 2026

(54) AUTOMOTIVE VEHICLE HAVING AUXILARY POWER TRAIN

(71) Applicant: Gregorio Belloso, Salisbury, MD (US)

(72) Inventor: Gregorio Belloso, Salisbury, MD (US)

(21) Appl. No.: 18/929,206

(22) Filed: Oct. 28, 2024

(51) Int. Cl. B60W 20/40; B60W 10/08

(52) U.S. Cl. CPC B60K 6/20

(57) ABSTRACT

A vehicular system designed to enhance performance and efficiency through the integration of dual power trains. The system comprises a primary power train featuring a main engine connected to a first torque converter, which is further linked to a speed change transmission. This transmission drives a propeller shaft connected to a differential, which in turn powers a plurality of drive wheels. Additionally, the system includes an auxiliary power train, which is connected to the main engine via the vehicle body. This auxiliary power train comprises an auxiliary engine linked to a second torque converter, which drives a transaxle connected to a plurality of front wheels. This configuration allows for optimized power distribution and improved vehicle dynamics, catering to various driving conditions and enhancing overall fuel efficiency.

### FIELD OF THE INVENTION

The present invention generally relates to automotive vehicles. More particularly, the present invention relates to automotive vehicles equipped with a plurality of auxiliary power trains in addition to a primary power train, aimed at improving fuel economy.

### BACKGROUND OF THE INVENTION

The increasing concern over global warming and climate change has focused significant attention on reducing greenhouse gas emissions from automotive vehicles. Notably, semi-trailer trucks and other large cargo trucks, which average a mere 6.5 to 7.5 miles per gallon, are significant contributors to greenhouse gas emissions, accounting for approximately 23% of all emissions from automotive sources.

There exists a critical need to improve the fuel efficiency of automotive vehicles, particularly those heavy-duty cargo vehicles that rely on fossil fuels. Prior art describes systems where multiple engine units are coupled to a transmission through an electromagnetic powered clutch, operating engines with a phase difference to prevent unwanted vibrations. However, the complexity of these systems limits their adaptability for automotive vehicles, especially for enhancing fuel efficiency.

Other disclosures describe wheeled vehicles employing multiple engines or motors, such as vehicles with a main engine driving the rear axle and a booster engine driving the front axle. While this configuration offers operational versatility when the main engine is overloaded, the additional power train components increase vehicle cost and weight without necessarily improving fuel efficiency.

Additionally, some prior art presents vehicles with a drive system featuring a primary internal combustion engine and a more fuel-efficient auxiliary engine. This auxiliary engine is activated at cruising speeds but lacks coupling to a speed change transmission, limiting its use to maintaining cruising speeds rather than lower speeds.

Despite these advancements, a cost-effective solution for significantly improving the fuel efficiency of automotive vehicles—particularly heavy-duty cargo trucks during long-distance highway travel—remains unavailable. Therefore, there is a pressing need to develop such a solution.

The present invention is intended to solve the problems associated with conventional devices and methods and provide improvements on these devices.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention introduces a dual power train system that reconciles the traditionally conflicting demands of maximum performance and fuel economy in automotive vehicles. This system is particularly beneficial for heavy-duty vehicles like semitrailer trucks, which require high-powered performance to haul substantial loads and tackle steep grades, while also needing improved fuel efficiency during lighter loads or cruising conditions.

High-performance power trains, often exceeding 600 horsepower, consume significant fuel even when lightly loaded, resulting in minimal fuel economy improvements between fully loaded and unloaded states. The innovation here lies in integrating a fuel-efficient auxiliary power train to handle light-duty operations, such as maintaining cruising speeds on level highways, thereby achieving substantial fuel savings.

The primary objective is to equip vehicles with a dual power train system: a robust primary power train for heavy-duty cycles and a lighter, auxiliary power train for light-duty cycles. This allows the primary engine to manage demanding tasks like acceleration and climbing, while the auxiliary engine efficiently maintains cruising speeds. Operators can seamlessly switch between power trains without interrupting travel, optimizing fuel usage based on driving conditions. The system's design facilitates easy retrofitting into existing vehicles and incorporation into new models, promising significant fuel savings when the auxiliary power train operates independently due to its superior efficiency.

The present invention provides a cost-effective solution to balance high performance with fuel economy, enhancing the operational efficiency of various vehicles from semitrailer trucks to sporty personal vehicles. The present invention offers economic and environmental benefits by reducing fuel consumption and emissions. The invention leverages existing automotive technology for improved fuel efficiency with minimal modifications, allowing for seamless transitions between power trains as needed without disrupting vehicle operation. These and other advantages will become apparent from the detailed description of the invention.

### BRIEF DESCRIPTION OF THE DRAWINGS

In light of these and other advantages, the present invention is described in the following specification and is further elucidated by the accompanying drawings, which are integral to its comprehensive understanding:

FIG. 1 illustrates a schematic top view of an embodiment of the power trains for the fuel-efficient vehicle of the present invention.

FIG. 2 provides a schematic top view of a first alternative embodiment of the fuel-efficient vehicle of the present invention.

FIG. 3 depicts a schematic top view of a second alternative embodiment of the fuel-efficient vehicle of the present invention.

FIG. 4 shows a schematic top view of a third alternative embodiment of the fuel-efficient vehicle of the present invention.

FIG. 5 represents a schematic top view of a fourth alternative embodiment of the fuel-efficient vehicle of the present invention.

FIG. 6 details a schematic top view of a fifth alternative embodiment of the fuel-efficient vehicle of the present invention.

FIG. 7 illustrates a schematic top view of a sixth alternative embodiment of the fuel-efficient vehicle of the present invention.

FIG. 8 presents a schematic top view of a seventh alternative embodiment of the fuel-efficient vehicle of the present invention.

FIG. 9 renders a schematic top view of an eighth alternative embodiment of the fuel-efficient vehicle of the present invention.

FIG. 10 shows a schematic top view of a ninth alternative embodiment of the fuel-efficient vehicle of the present invention.

FIG. 11 delineates a schematic top view of a tenth alternative embodiment of the fuel-efficient vehicle of the present invention.

To maintain clarity in the illustrations, elements not critical to the present invention—such as the vehicle's chassis and body, engine and transmission mounts, undercarriage, and internal specifics of the speed change transmission, differential, and transaxle—have been intentionally omitted from the drawings.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for providing enhanced fuel efficiency and performance in automotive vehicles, embodiments of the present disclosure are not limited to use only in this context.

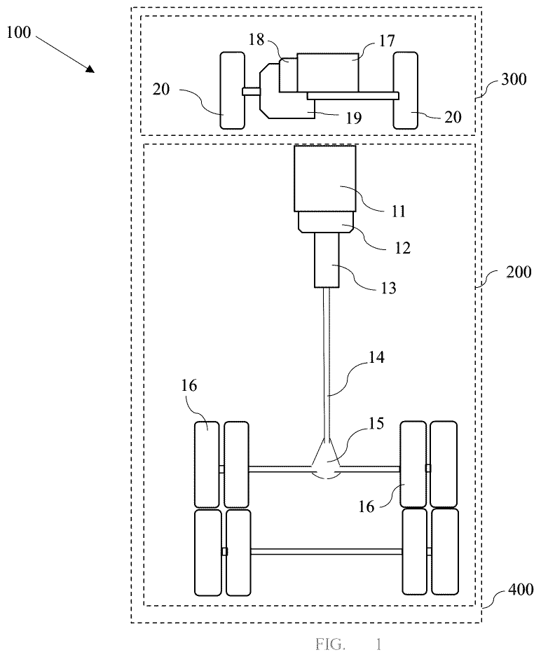

Referring to the accompanying drawing, FIG. 1 illustrates a schematic top view of one embodiment of the present invention, optimized for fuel-efficient, heavy-duty operations such as those of semitrailer trucks.

The present invention provides a system 100 comprising a primary power train 200 and an auxiliary power train 300, each optimized for distinct operational roles to enhance performance and efficiency. The primary power train 200 and an auxiliary power train 300 can be connected via a vehicle body 400, in some embodiments.

### Primary Power Train 200

In preferred embodiment, the primary power train 200 includes a Main Engine (11), Torque Converter or Clutch (12), Speed Change Transmission (13), Propeller Shaft (14), Differential (15), and a plurality of Drive Wheels (16).

Main Engine (11): In one embodiment, this can be a high-capacity diesel engine, delivering between 500 to 600 horsepower, crucial for handling heavy loads. Its design ensures optimal fuel efficiency, achieving 6.5 to 7.5 miles per gallon, effectively managing the vehicle's gross weight of up to 80,000 lbs.

Torque Converter or Clutch (12): This component connects the main engine to the speed change transmission (13). It enables smooth power transfer, allowing for the decoupling and coupling of the engine from the drivetrain as needed.

Speed Change Transmission (13): As a multi-speed gearbox, it tailors the engine's output to the vehicle's speed and load, ensuring efficient power management across varying driving conditions.

Propeller Shaft (14): This longitudinal shaft transmits rotational power from the transmission to the differential (15), ensuring a direct connection between these components.

Differential (15): Responsible for splitting engine torque between the drive wheels (16), it allows each wheel to rotate at different speeds, crucial for maneuvering, especially around curves. The differentials, including open, limited slip, locking, torque vectoring, spool, and Torsen, are mechanisms in vehicles that allow wheels to rotate at different speeds, enhancing traction and handling based on specific driving needs.

Drive Wheels (16): Located typically at the rear, these are powered by the differential to propel the vehicle forward during high-power operations.

### Auxiliary Power Train 300

Auxiliary Engine (17): This smaller, fuel-efficient engine provides approximately 130 horsepower, sufficient for maintaining cruising speeds on level roads, enhancing fuel economy.

Torque Converter or Clutch (18): Linking the auxiliary engine to the transaxle (19), this component ensures controlled transmission of power to the auxiliary drivetrain.

Transaxle (19): Combining the functions of a transmission and a differential, it distributes power to the front wheels (20), facilitating auxiliary propulsion for lighter, more efficient cruising.

Front Wheels (20): Powered by the auxiliary power train, these wheels enhance traction and efficiency when the vehicle is cruising at steady speeds.

In one embodiment, the present invention may provide a system 100 comprising:
a primary power train 200 including:
   a main engine 11,
   a first torque converter 12 connected to the main engine,
   a speed change transmission 13 connected to the first torque converter,
   a propeller shaft 14 connected to the speed change transmission,
   a differential 15 connected to the propeller shaft,
   a plurality drive wheels 16 connected to the differential 15,
   an auxiliary power train 300 connected to the main engine 11 via a vehicle body 400, the auxiliary power train 300 including:
   an auxiliary engine 17,
   a second torque converter 18 connected to the auxiliary engine,
   a transaxle 19 connected to the second torque converter 18, and
   a plurality of front wheels 20.

The system 100 allows drivers to seamlessly switch between the primary and auxiliary power trains 200, 300 through controls in the vehicle's cab. For high-demand situations, such as accelerating from a stop or climbing steep inclines, the primary power train 200 is engaged. Once at a cruising speed, the driver can engage the auxiliary power train 300, significantly increasing fuel efficiency through the smaller engine.

The seamless transition between primary and auxiliary power trains 200, 300 in a vehicle can be enabled using currently available automatic and manual control technologies as follows:

### Automatic Control System

Electronic Control Unit (ECU): In one embodiment, the present invention may include the ECU that can be programmed to automatically switch between the primary and auxiliary power trains based on real-time data inputs such as vehicle speed, engine load, and road gradient. For example, sensors can detect when the vehicle is accelerating from a stop or climbing an incline, prompting the ECU to engage the primary power train for maximum power output.

Adaptive Cruise Control (ACC): When the vehicle reaches a steady cruising speed on a highway, the ACC system can trigger the ECU to switch to the auxiliary power train, optimizing fuel efficiency. This transition is smooth and does not require driver intervention, enhancing convenience and efficiency.

### Manual Control System

Dashboard Switches or Buttons: In one embodiment, the present invention may include the dashboard that can be equipped with dedicated switches or buttons that allow the driver to manually select between the primary and auxiliary power trains.

Steering Wheel Controls: To enhance safety and convenience, controls for switching power trains could be integrated into the steering wheel, allowing the driver to make adjustments without taking their hands off the wheel.

By utilizing these technologies, drivers can effectively manage the transition between power trains, ensuring optimal performance and fuel efficiency under varying driving conditions.

This dual-power train configuration not only conserves fuel but also reduces greenhouse gas emissions, meeting critical needs in the trucking industry. The innovative setup depicted in FIG. 1 ensures robust performance and sustainability for heavy-duty vehicles, by allowing efficient transitions between power sources based on operational demand.

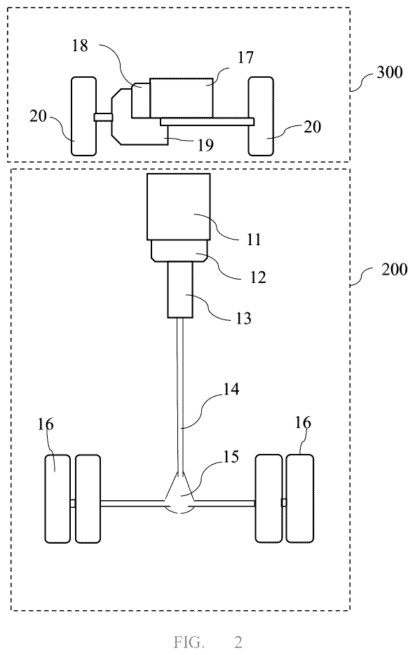

FIG. 2 provides a schematic top view of an alternative embodiment suitable for a regular-sized bus or a delivery truck featuring a front engine and rear-wheel drive. The primary engine (11) connects via a clutch or torque converter (12) to a speed change transmission (13), which in turn connects to the rear wheels (16) through a propeller shaft (14) and a differential (15). This vehicle also employs the auxiliary power train 200 of the invention like shown in FIG. 1, comprising an auxiliary engine (17) approximately 50% smaller than the primary engine (11). The auxiliary engine (17) powers the front wheels (20) through a clutch or torque converter (18) and a transaxle (19), enabling the driver to use the primary engine (11) for heavy-duty cycles like starting from a stop and climbing steep grades and then switch to the auxiliary engine (17) for maintaining cruising speed, thereby saving fuel.

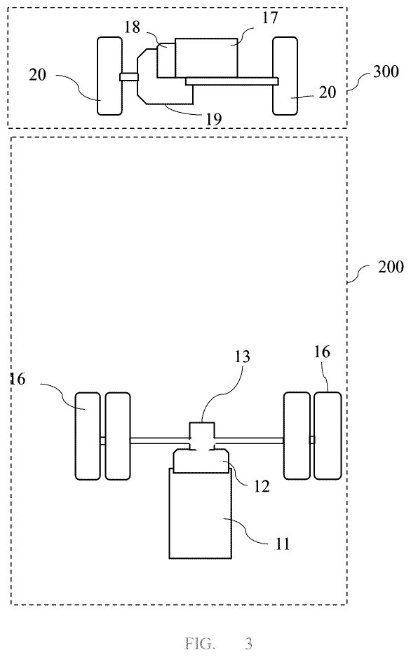

FIG. 3 illustrates a second alternative embodiment featuring a primary power train 200 typical of rear-engine, rear-wheel-drive vehicles, often used in city buses and tour buses. Primary engine (11), located at the rear, connects via a clutch or torque converter (12) to a speed change transaxle (13) that powers the rear wheels (16). Mainly, the primary engine (11) is utilized during high-power duty cycles such as acceleration from a stop and ascending grades. The auxiliary power train 300, situated at the front of the vehicle, includes a smaller auxiliary engine (17), coupled by a clutch or torque converter (18) to a speed change transaxle (19) that powers the front wheels (20). Auxiliary engine (17), generally about 50% smaller than the primary engine (11), is used primarily during light-duty cycles to maintain cruising speed, enabling the primary engine (11) to be decoupled and shut down, thereby conserving fuel.

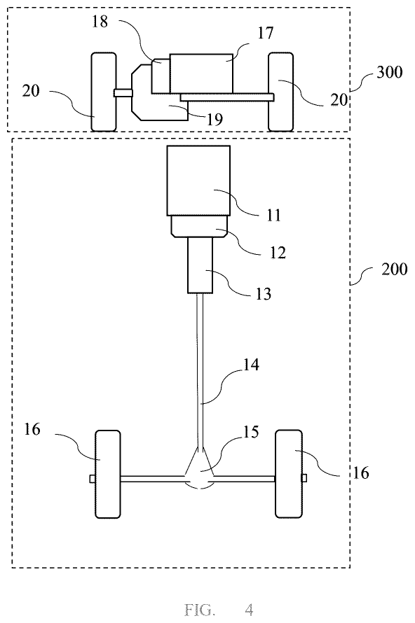

FIG. 4 showcases a third alternative embodiment for a fuel-efficient vehicle with a front engine and rear-wheel drive, such as pickup trucks and large cars. The primary engine (11), located under the hood, connects via a clutch or torque converter (12) to a speed change transmission (13), then via a propeller shaft (14) to a differential (15) and finally the rear wheels (16). This setup is primarily for heavy-duty cycles like starting from a stop, hauling heavy loads, and climbing grades. The auxiliary power train 300 comprises an auxiliary engine (17), roughly half the size and power of the primary engine (11), coupled to a transaxle (19) through a clutch or torque converter (18). The transaxle (19) drives the front wheels (20), allowing the auxiliary power train to maintain cruising speed so the primary engine (11) can be turned off, saving fuel.

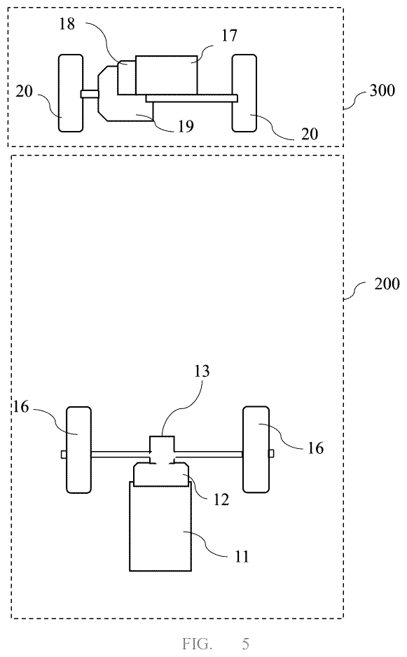

FIG. 5 depicts a fourth alternative embodiment where the primary power train 200 is that of a front-engine, front-wheel-drive vehicle, common in private cars, SUVs, and minivans. The primary engine (11) is linked through a clutch or torque converter (12) to a transaxle (19) driving the front wheels (20). Meanwhile, the auxiliary engine (17), about 50% smaller than the primary one (11), connects through a clutch or torque converter (18) to a transaxle (19) driving the rear wheels (16). This configuration allows the driver to use the primary engine (11) for high-power tasks and the auxiliary engine (17) for lighter tasks, such as maintaining cruising speed, turning off the primary engine (11) to conserve fuel.

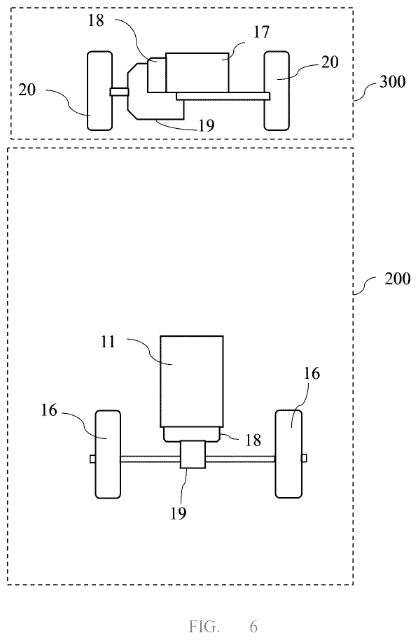

FIG. 6 offers a fifth embodiment, focusing on a mid-engine, rear-wheel-drive vehicle layout favored in high-powered sports cars for better weight distribution and improved cornering performance. This layout is preferred for high-powered sports cars due to its superior weight distribution and enhanced cornering performance at high speeds; however, while the typically large and powerful primary engine provides rapid acceleration, it results in poor fuel economy, even during leisurely drives on boulevards and highways. The primary engine (11) connects to a transaxle (19) via a clutch or torque converter (18) powering the rear wheels (16). The auxiliary engine (17), 40% to 60% smaller than the primary engine (11), couples to the front wheels (20) through a clutch or torque converter (18) and a transaxle (19), ensuring a balance of fast acceleration and fuel economy during cruising.

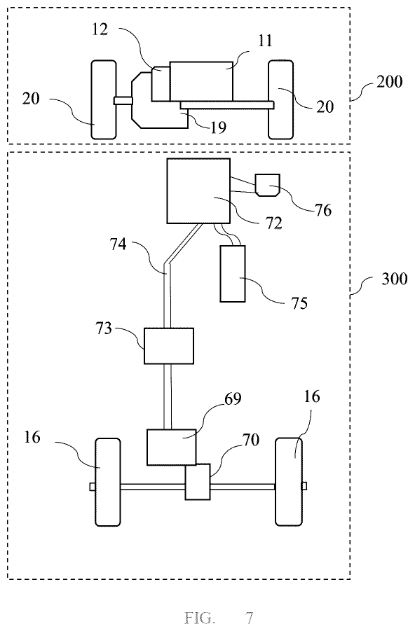

FIG. 7 is a schematic top view of the power train for a sixth alternative embodiment of this invention, featuring a front-engine, front-wheel-drive layout, commonly used in family cars, minivans, and SUVs. The primary engine (11) is coupled to a transaxle (19) via a torque converter or clutch (12), transmitting power to the front wheels (20).

The auxiliary power train 300 in this embodiment is electrically powered. It includes an electric motor (69) that transmits mechanical power through a single-ratio transaxle (70) to the rear wheels 16. Electricity is stored in a battery pack 72 and supplied to the electric motor through a controller 73, which regulates the electricity supply via electrical connections 74. The battery pack 72 is recharged from the grid through an onboard charger 75, which can be plugged into a 110-volt or 220-volt outlet, or from a DC charger at commercial stations via a plug port 76.

This electric-powered auxiliary power train 300 offers specific advantages over traditional systems, such as the downsized internal combustion engine. The fuel cost using electric power is about five cents per mile, compared to approximately 13 cents per mile with fossil fuel. Using the electric power train for auxiliary purposes, such as cruising, rather than acceleration or climbing (handled by the primary engine), allows for a battery pack 72 with about half the power density of regular electric vehicles.

If the electric auxiliary power train 300 is used during the 98% of household car trips that are less than 50 miles long, and considering that the primary power train (11) can extend the range for several hundred miles for the 2% of trips that exceed 50 miles, it becomes feasible to use batteries with up to 75% less energy and power density than regular electric vehicles. This significantly reduces battery costs. Surveys show that 98% of household car trips are under 50 miles, eliminating range anxiety.

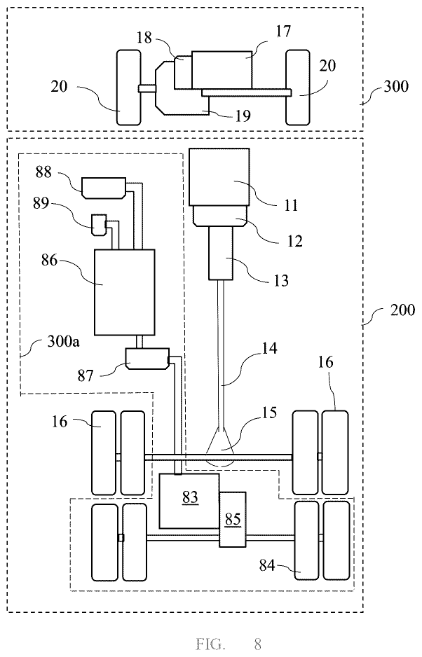

FIG. 8 is a schematic top view of the power train for a seventh alternative embodiment of this invention, optimized for heavy-duty, long-distance cargo and passenger transport. It focuses on maximizing fuel economy and reducing emissions while minimizing initial battery costs and eliminating range anxiety.

### Primary Power Train

Main Engine (11): The primary engine connected via a clutch or torque converter (12) to a speed change transmission (13).

Torque Converter or Clutch (12): Facilitates smooth power transfer from the main engine to the transmission.

Speed Change Transmission (13): Adjusts the engine's output to match the vehicle's speed and load.

Propeller Shaft (14): Transmits rotational power to the differential (15).

Differential (15): Splits engine torque between the drive wheels (16).

Drive Wheels (16): Propelled by the differential for high-power operations.

### First Auxiliary Power Train 300a

Electric Motor (83): Drives the first auxiliary driving wheels (84) via a single-ratio transmission (85).

Battery Pack (86): Supplies electricity to the electric motor (83) through a controller (87) that regulates the power supply.

Controller (87): Manages the electricity flow to the electric motor.

Onboard Charger (88): Allows the battery to be recharged with AC current from the grid.

DC Charging Plug-in Port (89): Enables recharging with DC current from charging stations.

First Auxiliary Driving Wheels (84): Powered by the electric motor for efficient cruising.

### Second Auxiliary Power Train 300

Auxiliary Engine (17): A smaller engine providing additional propulsion.

Clutch or Torque Converter (18): Connects the auxiliary engine to the transaxle (19).

Transaxle (19): Distributes power to the second auxiliary driving wheels (20).

Second Auxiliary Driving Wheels (20): Powered by the auxiliary engine for enhanced efficiency.

During operation, the main engine (11) is used for heavy-duty tasks, such as acceleration and climbing. For lighter tasks, such as cruising on level highways, the battery-driven first auxiliary power train is used for up to a 60% savings in energy. Once the battery is depleted, the second auxiliary power train with its downsized engine offers up to a 50% fuel saving, enhancing the vehicle's overall efficiency.

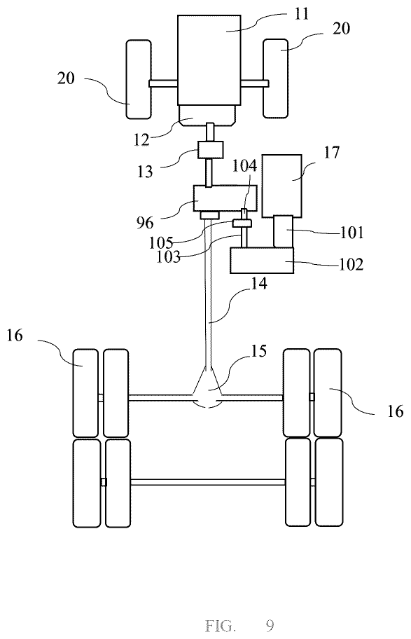

FIG. 9 is a schematic top view of an eighth alternative embodiment of the invention, optimized for the easy conversion of a standard semitrailer truck into a fuel-efficient dual power train truck.

### Primary Power Train 200

Main Engine (11): Connected via a clutch or torque converter (12) to a speed change transmission (13).

Speed Change Transmission (13): Transfers power to the primary transfer case (96).

Primary Transfer Case (96): Directs power to the primary propeller shaft (14).

Primary Propeller Shaft (14): Transmits power to the differential (15).

Differential (15): Distributes power to the driving wheels (16).

Driving Wheels (16): Propelled by the differential for high-power operations.

### Auxiliary Power Train 300

Auxiliary Engine (17): Approximately 50% the size and power capacity of the primary engine (11).

Clutch or Torque Converter (18): Connects the auxiliary engine to the auxiliary speed change transmission (101).

Auxiliary Speed Change Transmission (101): Outputs power to the auxiliary transfer case (102).

Auxiliary Transfer Case (102): Connects to the secondary propeller shaft (103).

Secondary Propeller Shaft (103): Links to the lateral input shaft (104) of the primary transfer case (96) via a universal joint (105).

### Operation

During heavy-duty cycles, such as acceleration and climbing, the primary engine (11) is used. For lighter duty cycles, like maintaining cruising speed on straight and level highways, the operator can start the auxiliary engine (17) and transmit power to the driving wheels (16) via the auxiliary transmission (101), auxiliary transfer case (102), secondary propeller shaft (103), primary transfer case (96), primary propeller shaft (14), and differential (15). The operator can then shift the primary speed change transmission (13) to neutral, stop the primary engine (11) to save fuel, and continue cruising with the more fuel-efficient auxiliary engine (17), while the primary engine remains ready for reactivation when more power is needed.

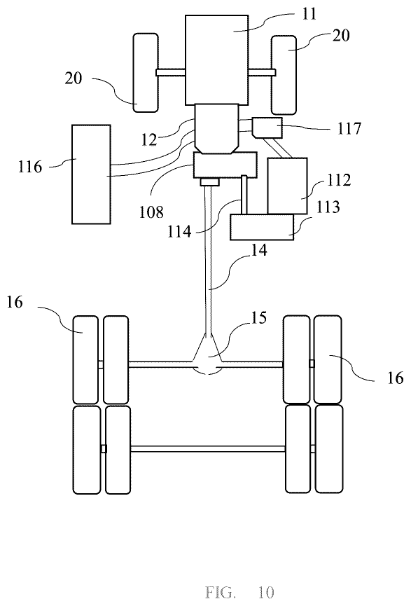

FIG. 10 illustrates a schematic top view of a power train configuration. The primary engine (11) is connected via a clutch or torque converter (12) to a speed change transmission (13), which then connects through a transfer case (108) to a propeller shaft (14), differential (15), and driving wheels (16).

An electric motor-generator (112) is linked through a single-ratio transmission (113) and an auxiliary propeller shaft (114) to the transfer case (108). This setup allows the motor-generator (112) to transmit power to the driving wheels (16) when functioning as a motor, and to receive power from the driving wheels (16) when operating as a generator.

### Operation:

Heavy Duty Cycles: The primary engine (11) is used for tasks like accelerating from a stop and climbing inclines.

Lighter Duty Cycles: For maintaining cruising speed, the motor-generator (112) can be used. It transmits power through the single-ratio transmission (113), transfer case (108), propeller shaft (14), differential (15), and driving wheels (16). This enables fuel-efficient travel using electricity stored in a rechargeable battery (116), supplied to the motor-generator (112) via a controller (117).

### Regenerative Braking:

Energy from the driving wheels (16) is conveyed through the differential (15), propeller shaft (14), transfer case (108), auxiliary propeller shaft (114), and single-ratio transmission (113) to generate electricity via the motor-generator (112) in generator mode during braking.

When operating on electric power, the primary engine (11) is shut down to conserve fuel, ready to be reactivated when additional power is needed.

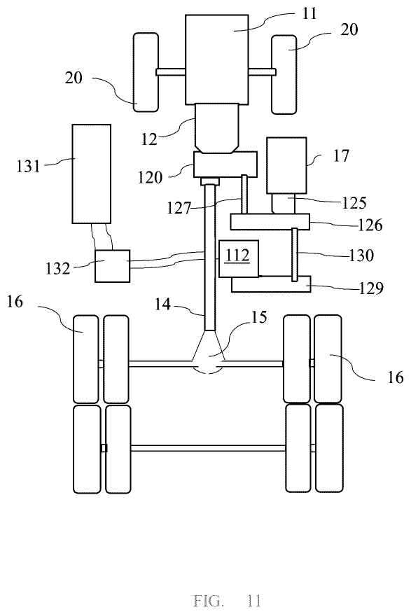

FIG. 11 is a schematic top view of a tenth alternative embodiment of the invention, optimized for maximizing fuel efficiency and minimizing exhaust emissions, particularly in semitrailer trucks on long-distance routes.

### Primary Power Train 200

Primary Engine (11): Coupled via a clutch or torque converter (12) to a speed change transmission (13), then to a transfer case (120).

Transfer Case (120): Connects to the propeller shaft (14).

Propeller Shaft (14): Transmits power to the differential (15).

Differential (15): Distributes power to the driving wheels (16).

Driving Wheels (16): Used for heavy-duty cycles like acceleration and hill climbing.

### Auxiliary Power Train 300

Auxiliary Engine (17): Connected to an auxiliary speed change transmission (125).

Auxiliary Speed Change Transmission (125): Links to the auxiliary transfer case (126).

Auxiliary Transfer Case (126): Connects via an auxiliary propeller shaft (127) to the transfer case (120).

Auxiliary Propeller Shaft (127): Integrates auxiliary power into the Primary Power Train 200.

### Electric Power Train

Motor-Generator (112): Coupled to a single-ratio transmission (129).

Single-Ratio Transmission (129): Connects to the auxiliary transfer case (126) via output shaft (130).

Rechargeable Battery Pack (131): Supplies electricity to the motor-generator (112).

Controller (132): Manages the flow of electricity to and from the motor-generator (112).

### Operation:

Heavy Duty Cycles: The primary engine (11) is used for tasks like accelerating from a stop or climbing hills.

Light Duty Cycles: The auxiliary engine (17) or motor-generator (112) can be used for maintaining cruising speed, with the primary engine (11) shut down to save fuel.

Regenerative Braking: The motor-generator (112) can receive power during braking to improve fuel economy.

This configuration provides a strong primary engine for fast acceleration and a smaller, fuel-efficient auxiliary engine for economical cruising, with the option to use a non-polluting electric motor.

This invention addresses the challenge buyers face in choosing between high-performance and fuel-efficient vehicles, providing a versatile solution that offers both fast acceleration and significantly improved cruising economy, reducing pollution and operating costs effectively.

Various embodiments of the invention can be realized as follows:

In one embodiment, an automotive vehicle having a body and chassis, control means within said vehicular body, a primary power train 200 comprising a primary engine 11, speed change transmission 13, propeller shaft 14, and differential 15, with front and rear paired wheels 20, 16, one of which is associated with the differential 15 and constitutes driving wheels 16, the improvement comprises:
a. An auxiliary power train 300 with a smaller, more fuel-efficient engine than the primary engine 11, yet capable of maintaining regular cruising speed, with significantly lower power than the primary power train 200.
b. Auxiliary drivetrain 300 means, including an auxiliary speed change transmission 101, auxiliary propeller shaft 114, differential 15, and auxiliary driving wheels 84, enabling the vehicle to be accelerated to cruising speed using power from the primary power train 200 and subsequently travel at cruising speed using power from the auxiliary power train 300, thereby reducing fuel consumption while the primary power train 200 is disconnected and shut down to save fuel.
c. The primary power train 200 remains ready to be activated whenever increased power is needed.

In some embodiments, a heavy-duty truck tractor used to pull semitrailers, the primary engine 11 is a heavy-duty engine with a power capacity of 400 to 700 HP and a fuel economy of 6.5 to 7.5 mpg. The improvement comprises:
a. An auxiliary power train 300 with an engine capacity of approximately 200 to 350 HP, estimated to deliver 12 to 14 mpg, enabling acceleration from a stop or up a highway with the primary engine 11, and cruising with the auxiliary engine 17, improving fuel efficiency.

In some embodiments, a vehicle like a delivery truck or school bus with a front engine of 200 to 300 HP and rear-wheel drive, the improvement comprises:
a. An auxiliary power train 300 with an engine of 100 to 150 HP, coupled to an auxiliary drivetrain driving the front wheels 20, allowing the vehicle to accelerate using the primary engine 11 and cruise with the auxiliary engine 17 for fuel economy.

In some embodiments, heavy-duty, rear-engine vehicles like large buses with engines of 400 to 600 HP and fuel economy of 6.5 to 7.5 mpg, the improvement comprises:
a. An auxiliary power train 300 with an engine of 200 to 300 HP, driving front wheels 20, facilitating cruising speeds with improved fuel use while keeping the primary engine 11 ready for activation when needed.

In some embodiments, high-powered sports cars with fast acceleration and poor fuel economy, the improvement comprises:
a. An auxiliary power train 300 using an engine 40—50% smaller than the primary engin3 11, coupled to the front wheels 20, for cruising while the primary engine 11 is disengaged to save fuel, yet ready to reactivate for more power.

In some embodiments, vehicles like sedans or SUVs with front-wheel drive, the improvement includes:
a. An auxiliary power train 300 roughly half the size of the primary engine 11, powering rear wheels 16, to cruise efficiently, disengaging the primary engine 11 to save fuel and keeping it ready when additional power is necessary.

In some embodiments, light sports cars with rear engines above 400 HP and poor fuel efficiency, the improvement comprises:
a. An auxiliary power train (300) 50-60% less powerful than the primary 200, placed near the front axle for better cruising efficiency while maintaining quick access to primary power.

In some embodiments, front-engine, front-wheel drive vehicles, the improvement comprises:
a. A battery-electric auxiliary power train 300 involving electric motors and a rechargeable battery, facilitating cruising with electric power, and recharging capabilities.

In some embodiments, vehicles with primary internal combustion engines for initial acceleration or inclines have an improvement involving:
a. A first auxiliary power train 300a powered by a battery for cruising, and a second auxiliary power train 300 with a smaller combustion engine for continued travel after battery depletion, while keeping the primary engine ready for activation.

In some embodiments, heavy-duty truck tractors, the improvement comprises:
a. Parallel auxiliary and primary engines 17, 11 powering the vehicle for cruising with the auxiliary engine, while the primary is disengaged but ready to activate for more power.

In some embodiments, heavy-duty truck tractors with a motor-generator for cruising using stored battery power, with provision for battery recharging.

In some embodiments, hybrid auxiliary engines enable vehicles to cruise economically without fossil fuels, engaging primary power when batteries are depleted.

Although the invention has been explained in relation to its preferred embodiment, it is to be understood that many other possible modifications and variations can be made without departing from the spirit and scope of the invention.

What is claimed is:

1. A system comprising:
a primary power train including:
a main engine,
a first torque converter connected to the main engine,
a speed change transmission connected to the first torque converter,
a propeller shaft connected to the speed change transmission,
a differential connected to the propeller shaft,
a plurality drive wheels connected to the differential,
an auxiliary power train connected to the primary power train via a vehicle body, the auxiliary power train including:
an auxiliary engine,
a second torque converter connected to the auxiliary engine,
a transaxle connected to the second torque converter, and
a plurality of front wheels connected to the transaxle.

2. The system as claimed in claim 1, wherein the main engine is a high-capacity diesel engine configured to deliver between 500 to 600 horsepower.

3. The system as claimed in claim 2, wherein the first torque converter configured to provide decoupling and coupling of the main engine from the primary power train.

4. The system as claimed in claim 3, wherein the speed change transmission is a multi-speed gearbox,

5. The system as claimed in claim 1, wherein the propeller shaft is a longitudinal shaft configured transmit rotational power to the differential, ensuring a direct connection.

6. The system as claimed in claim 1, wherein the differential is configured to split engine torque between the drive wheels, allowing each wheel to rotate at different speeds.

7. The system as claimed in claim 6, wherein the plurality drive wheels are located at a rear portion of a vehicle.

8. The system as claimed in claim 1, wherein the auxiliary engine is dimensionally smaller than the main engine.

9. The system as claimed in claim 1, wherein the auxiliary engine provides 130 horsepower.

10. A system comprising:
a primary power train including:
a main engine,
a first torque converter connected to the main engine,
a speed change transmission connected to the first torque converter,
a propeller shaft connected to the speed change transmission,
a differential connected to the propeller shaft,
a plurality of first drive wheels connected to the differential,
a first auxiliary power train connected to the primary power train via a vehicle body, the first auxiliary power train including:
at least one electric motor connected to the plurality of second drive wheels,
at least one controller connected to the at least one electric motor,
a second auxiliary power train connected to the primary power train via a vehicle body, the second auxiliary power train including:
an auxiliary engine,
a second torque converter connected to the auxiliary engine,
a transaxle connected to the second torque converter, and
a plurality of front wheels connected to the transaxle.

11. The system as claimed in claim 10, wherein the speed change transmission is a multi-speed gearbox,

12. The system as claimed in claim 11, wherein the propeller shaft is a longitudinal shaft configured transmit rotational power to the differential, ensuring a direct connection.

13. The system as claimed in claim 10, wherein the first auxiliary power train further includes at least one battery pack

14. The system as claimed in claim 13, wherein the first auxiliary power train further at least one onboard charger.

15. The system as claimed in claim 10, wherein the auxiliary engine of the second auxiliary power train includes a combustion engine.

16. A system comprising:
a primary power train including:
a main engine connected to a first drive wheels,
a first torque converter connected to the main engine,
a speed change transmission connected to the first torque converter,
a transfer case connected to the speed change transmission,
a propeller shaft connected to the transfer case,
a differential connected to the propeller shaft,
a plurality of second drive wheels connected to the differential,
a first auxiliary power train connected to the primary power train via a vehicle body, the first auxiliary power train including:
at least one electric motor,
at least one controller connected to the at least one electric motor,
a single-ratio transmission coupled to the at least one electric motor,
an output shaft connected to the single-ratio transmission,
a second auxiliary power train connected to the primary power train via a vehicle body, the second auxiliary power train including:
an auxiliary engine,
an auxiliary speed change transmission connected to the auxiliary engine, and
an auxiliary transfer case connected to the auxiliary speed change transmission and the output shaft, wherein the auxiliary transfer case is connected via an auxiliary propeller shaft to the transfer case.

17. The system as claimed in claim 16, wherein the speed change transmission is a multi-speed gearbox,

18. The system as claimed in claim 17, wherein the propeller shaft is a longitudinal shaft configured to transmit rotational power to the differential, ensuring a direct connection.

19. The system as claimed in claim 16, wherein the system further includes an automatic control system configured to provide transition between the primary and the auxiliary power train.

20. The system as claimed in claim 16, wherein the system further includes a manual control system configured to provide transition between the primary and the auxiliary power train.
